(19) United States
(12) Patent Application Publication
(10) Pub. No.: US 2017/0177757 A1
(43) Pub. Date: Jun. 22, 2017

(54) System and Method for Providing Interactive Wiring Diagram

(71) Applicant: Bosch Automotive Service Solutions Inc., Warren, MI (US)

(72) Inventors: Simon M. Thorley, South Lyon, MI (US); William W. Wittliff, III, Gobles, MI (US)

(21) Appl. No.: 14/979,196

(22) Filed: Dec. 22, 2015

(51) Int. Cl. G06F 17/50; H04N 5/232

(52) U.S. Cl. CPC G06F 17/5009; H04N 5/23229

(57) ABSTRACT

A method for providing an interactive wiring diagram is provided. The method includes receiving, at a processor of a wireless device, from an image sensor of the wireless device, an image of a wire loom between a first vehicle component and a second vehicle component of a vehicle, the wire loom including a plurality of wire connections of the vehicle. The method includes determining, using a position sensor of the wireless device, a position of the wire loom relative to the vehicle and to the wireless device. The method includes identifying, using a database, a wire connection based upon at least the image or the position of the wire loom. The method includes generating an interactive wiring diagram of the wire connection based upon the identifying. The interactive wiring diagram includes a trace route indicating a presence of a third vehicle component between the first and the second vehicle component.

### FIELD OF THE DISCLOSURE

The present disclosure generally pertains to the field of testing devices for vehicles. More particularly, the present disclosure relates to a system and a method for providing an interactive wiring diagram on a wireless device.

### BACKGROUND OF THE DISCLOSURE

Traditional wiring diagrams are large in size when printed on a sheet of paper and are shown as schematics in which each wire line represents a wire connection, rather than actual wiring. Typically, a technician will print a wiring diagram onto a sheet of paper and trace a circuit using a highlighter, marker, etc. In some cases, wiring diagrams of circuits require multiple pages to be printed fully. In other cases, printing the wiring diagram on an 8.5″×11″ sheet of paper creates a chart that is difficult to read by the human eye. Further, absent the knowledge of pin numbers of connectors in a wiring represented by the wiring diagram, it is not easy to directly correlate the points in the printed wiring diagram to the actual physical wiring of a wire loom seen by the technician. Even when the technician is knowledgeable about the pin numbers, it is time consuming and error prone for the technician to correlate the wiring diagram connectors to the actual connectors in the wiring, which usually is a jumble of many wires. Furthermore, even experienced technicians will often end up cutting a wiring loom far more than necessary to identify a high failure rate splice.

In some cases, technicians may have a mobile phone and use it to read wiring schematics for diagnosis of vehicles. Reading a wiring schematic from a mobile phone is tedious given the space constraints of the screen of the mobile device, and still suffers from the similar drawbacks as above.

Accordingly, there is a need for comfortable viewing of the wiring diagram and accurate identification of failure components in the actual wiring diagram.

### SUMMARY OF THE DISCLOSURE

The foregoing needs are met, to a great extent, by the present disclosure, wherein in one aspect, a system and a method for providing an interactive wiring diagram on a wireless device are disclosed.

In accordance with one aspect of the present disclosure, a method for providing an interactive wiring diagram is provided. The method includes receiving, at a processor of a wireless device, from an image sensor of the wireless device, an image of a wire loom between a first vehicle component and a second vehicle component of a vehicle, the wire loom including a plurality of wire connections of the vehicle. The method includes determining, using a position sensor of the wireless device, a position of the wire loom relative to the vehicle and to the wireless device. The method includes identifying, using a database connected to the processor, a wire connection based upon at least the image or the position of the wire loom. The method includes generating, using the processor, an interactive wiring diagram of the wire connection based upon the identifying, the interactive wiring diagram including a trace route indicating a presence of at least a third vehicle component between the first vehicle component and the second vehicle component. The method includes displaying, using the processor, the interactive wiring diagram on a display of the wireless device. The method includes receiving, at the processor, an input specifying a starting point and an end point in the trace route. The method includes providing, using the processor, an animation of the interactive wiring diagram based upon the starting point and the end point on the display based upon the input received at the processor.

In accordance with another aspect of the present disclosure, a system for providing an interactive wiring diagram is provided. The system includes a wire loom between a first vehicle component and a second vehicle component of a vehicle. The wire loom includes a plurality of wire connections. The system includes a wireless device including at least an image sensor, a position sensor, a display, a memory including processor executable instructions, and a processor coupled to the memory, the display, the image sensor, and the position sensor. The processor, upon an execution of the processor executable instructions, is configured to receive, from the image sensor of the wireless device, an image of the wire loom, determine, using the position sensor of the wireless device, a position of the wire loom relative to the vehicle and to the wireless device, identify, using a database connected to the processor, a wire connection in the wire loom based upon at least the image or the position of the wire loom, generate an interactive wiring diagram of the wire connection after the wire connection has been identified, the interactive wiring diagram including a trace route indicating a presence of at least a third vehicle component between the first vehicle component and the second vehicle component, display the interactive wiring diagram on the display of the wireless device, receive an input specifying a starting point and an end point in the trace route, and provide an animation of the interactive wiring diagram based upon the starting point and the end point on the display based upon the input received at the processor.

In accordance with yet another aspect of this disclosure, a non-transitory computer readable medium of a wireless device including processor executable instructions stored thereupon for providing an interactive wiring diagram is provided. The processor executable instructions when executed by a processor of the wireless device, cause the processor to receive, from the image sensor of the wireless device, an image of the wire loom, determine, using the position sensor of the wireless device, a position of the wire loom relative to the vehicle and to the wireless device, identify, using a database connected to the processor, a wire connection in the wire loom based upon at least the image or the position of the wire loom, generate an interactive wiring diagram of the wire connection after the wire connection has been identified, the interactive wiring diagram including a trace route indicating a presence of at least a third vehicle component between the first vehicle component and the second vehicle component, display the interactive wiring diagram on the display of the wireless device, receive an input specifying a starting point and an end point in the trace route, and provide an animation of the interactive wiring diagram based upon the starting point and the end point on the display based upon the input received at the processor.

There has thus been outlined, rather broadly, certain aspects of the disclosure in order that the detailed description herein may be better understood, and in order that the present contribution to the art may be better appreciated. There are, of course, additional aspects of the present disclosure that will be described below and which will form the subject matter of the claims appended hereto.

In this respect, before explaining at least one aspect of the present disclosure in detail, it is to be understood that the present disclosure is not limited in its application to the details of construction and to the arrangements of the components set forth in the following description or illustrated in the drawings. The present disclosure is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

### BRIEF DESCRIPTION OF THE DRAWINGS

FIG. 1 illustrates an example portion of a vehicle including a plurality of wire looms and other vehicle components.

FIG. 2 illustrates example internal structure of a wire loom having a plurality of wire connections in the vehicle of FIG. 1.

FIG. 3 illustrates a schematic wiring diagram corresponding to one of the wire loom of FIG. 2, in which the wire connections are represented as straight lines between various connection points.

FIG. 4A illustrates a first view of a wireless device, according to an exemplary aspect of the present disclosure.

FIG. 4B illustrates a second view of the wireless device of FIG. 4A, according to another exemplary aspect of the present disclosure.

FIG. 5 illustrates a schematic circuit diagram of the wireless device of FIGS. 4A and 4B, according to an exemplary aspect of this disclosure.

FIG. 6 illustrates a system for providing an interactive wiring diagram for the wire loom in the vehicle, according to an exemplary aspect of this disclosure.

FIG. 7 illustrates the interactive wiring diagram as presented on a display of the wireless device, according to an exemplary aspect of this disclosure.

FIG. 8 illustrates a cutting depth of the displayed wire loom for identifying a potential fault in a wire connection in the wiring loom, according to an exemplary aspect of this disclosure.

FIGS. 9A, 9B, and 9C illustrate an animation of the wire loom shown at three example time instants, according to an exemplary aspect of this disclosure.

FIG. 10 illustrates a method for providing an interactive wiring diagram for a wire connection of the wire loom in the vehicle, according to an exemplary aspect of this disclosure.

### DETAILED DESCRIPTION

The present disclosure will now be described with reference to the drawing figures, in which like reference numerals refer to like parts throughout. An aspect in accordance with the present disclosure provides an interactive wiring diagram for comfortable viewing by a vehicle technician and for interaction by the technician on a wireless device.

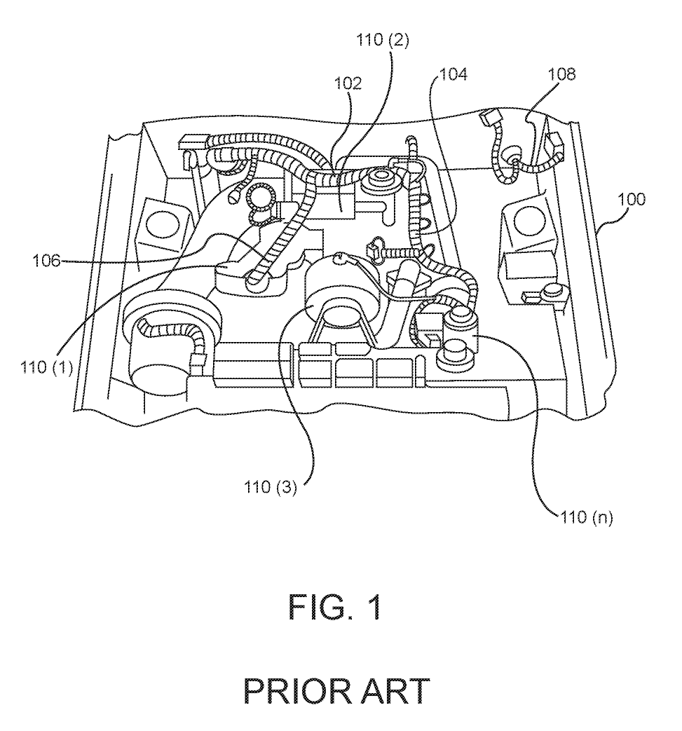

Referring to FIG. 1, there is illustrated, a view of an example portion of a vehicle 100. In FIG. 1, an example arrangement of parts under a hood of the vehicle 100 includes a plurality of wire looms 102, 104, 106, and 108, although the vehicle 100 may include a higher or a lower number of wire looms, including wire looms in other portions of the vehicle 100, not shown in FIG. 1. It will be appreciated by one of ordinary skill in the art that though FIG. 1 illustrates the vehicle 100, various aspects of the present disclosure are applicable to machines and apparatus that include wire looms for electrical connections between components thereof. For example, instead of the vehicle 100, the plurality of wire looms 102, 104, 106, and 108 may be present inside a heavy electrical machine, a transformer, a power plant, a server farm, a computing system, and the like. Generally, various aspects of the present disclosure are applicable anywhere where wire looms are used. The term “wire” may refer to an electrical wire, an optical fiber, or both, as indicated by a context in which this term is utilized. The additional components of the vehicle 100 shown in FIG. 1 may include vehicle components 110(1)-110(n) (‘n’ being a positive integer index) including alternators, engine, batteries, drives, sensors, electronic control units or modules, known to one of ordinary skill in the art.

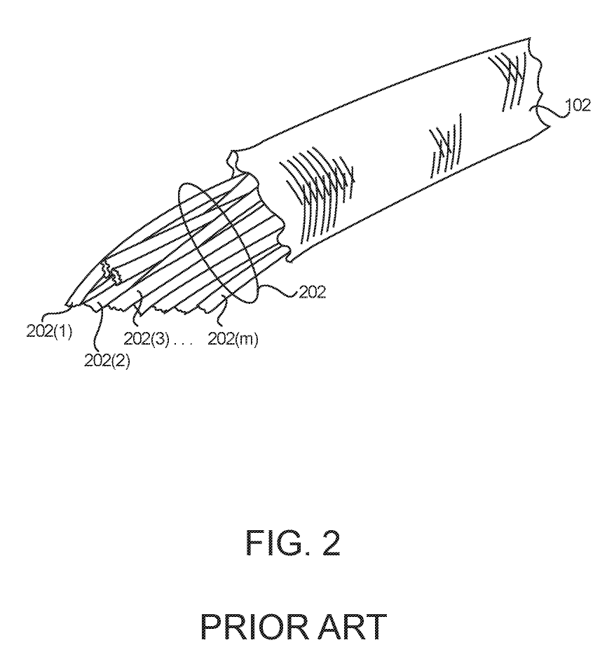

Referring to FIG. 2, the wire loom 102 includes a plurality of wire connections 202. The plurality of wire connections 202 include wires 202(1), 202(2), . . . , 202(m), where index ‘m’ is a positive integer. Although not explicitly shown in FIG. 2, each of the wires 202(1)-202(m) connects two or more of the vehicle components 110(1)-110(n) of the vehicle 100 at each end of the wires 202(1)-202(m). In some occasions, the wires 202(1)-202(m) may be completely hidden from a view of a technician or an operator or a computer-vision assisted robot by virtue of being inside the wire loom 102 (or, for that matter, any of the wire looms 104, 106, 108, etc.). A robot may be used, for example, when the vehicle 100 is in a hazardous condition or in a machine having the wire looms 102-108 in a constrained space. Even when one or more of the wires 202(1)-202(m) are partially visible, a technician viewing the plurality of wire looms 102, 104, 106, and 108 of the vehicle 100, as illustrated in FIG. 1, may not always know, just based upon the view in FIG. 1, which ones of the wires 202(1)-202(m) correspond to which connections of the vehicle components 110(1)-110(n) in the vehicle 100.

Further, the view of the plurality of wire looms 102, 104, 106, and 108 may include only parts of one or more of the plurality of wire looms 102, 104, 106, and 108 available to the technician. Such a view may not indicate a presence of connectors, splices, ground points, and/or other intermediary electrical or optical points that may be prone to failure over a period of time. For example, due to a presence of other components of the vehicle 100, the wire loom 102 may be seen as two separate wire looms since the component may block a complete view of the wire loom 102 and may come to an incorrect determination of which components the wire loom 102 connects in the vehicle 100. Furthermore, even the most experienced technician or an automated robot may misidentify the plurality of wire looms 102, 104, 106, and 108 when the plurality of wire looms 102, 104, 106, and 108 are in plain view due to human error and/or obsolete data provided to the robot for recognizing various components.

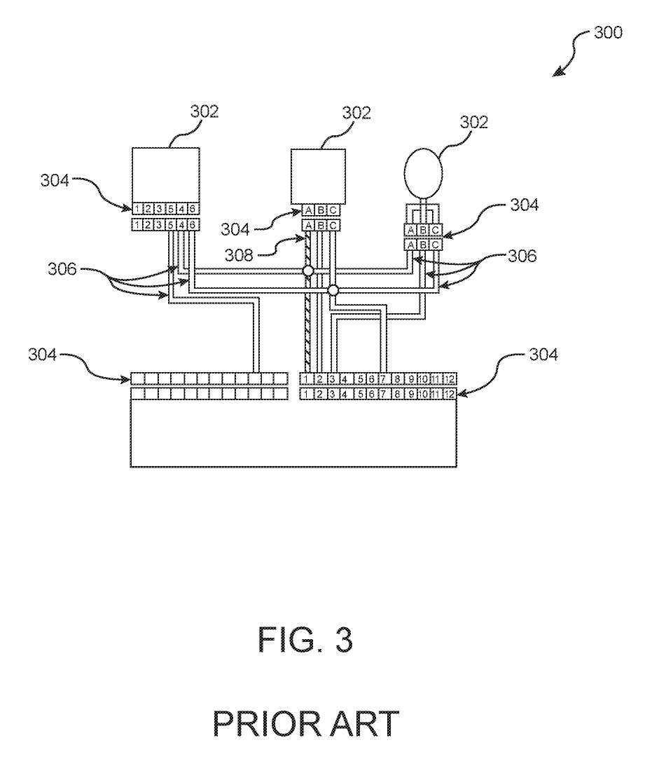

Typically, as illustrated in FIG. 3, the technician or the operator relies upon a schematic wiring diagram 300, where the wires 202(1)-202(m) are represented as lines between electrical connectors 304, to identify the wire looms 102, 104, 106, and/or 108. The schematic wiring diagram 300 may be printed on multiple pages due to a size of the schematic wiring diagram 300. On a paper, the technician may use a visual marker to identify specific ones of the wires 202(1)-202(m) and highlight one or more of the wires 202(1)-202(m) of interest as provided on the interactive wiring diagram 700. However, as will be appreciated by one of ordinary skill in the art, the schematic wiring diagram 300 does not have an easily discernible one-to-one mapping or correspondence between the wires 202(1)-202(m) and the vehicle components 110(1)-110(n). For example, the vehicle components 110(1)-110(n) displayed on the schematic wiring diagram 300 could represent a bank angle sensor, a throttle position sensor, a cam position sensor and an electronic control module, or any additional vehicle components related to the schematic wiring diagram 300. The technician needs to have exact knowledge of where the vehicle components 110(1)-110(n) as illustrated in the schematic wiring diagram 300 are present inside the vehicle 100.

The schematic wiring diagram 300 can further include the electrical connectors 304 for the vehicle components 110(1)-110(n) and wire drawings 306 coupling the electrical connectors 304. For example, a bank angle sensor connector, a throttle position sensor connector, a cam position sensor connector, a first ECM connector and a second ECM connector, or any additional electrical connectors may be represented on the schematic wiring diagram 300. In addition, the schematic wiring diagram 300 can include any number of wires in addition to the wires 202(1)-202(m) coupling the vehicle components 110(1)-110(n).

In order to illustrate a specific wire connection (e.g., that of the wire 202(1)), the vehicle technician needs to highlight one or more items on the schematic wiring diagram 300, for example, highlighted wires 308 shown in FIG. 3 that correspond to the specific wire connection. However, as noted above, the technician has to identify schematic components 302 with the vehicle components 110(1)-110(n) and the electrical connectors 304 with actual electrical connectors of the wire looms 102, 104, 106, and 108 (e.g., as seen under the hood of the vehicle 100 in FIG. 1), either using a schematics manual or from his/her memory. Such identification using a manual or from memory of the technician is cumbersome, time consuming, and error-prone. Further, the schematic wiring diagram 300 does not provide information about a location of the vehicle components 110(1)-110(n) relative to the vehicle 100 and the technician has to look back and forth between the actual view of the vehicle 100 and the schematic wiring diagram 300 to identify the vehicle component of interest in the vehicle components 110(1)-110(n).

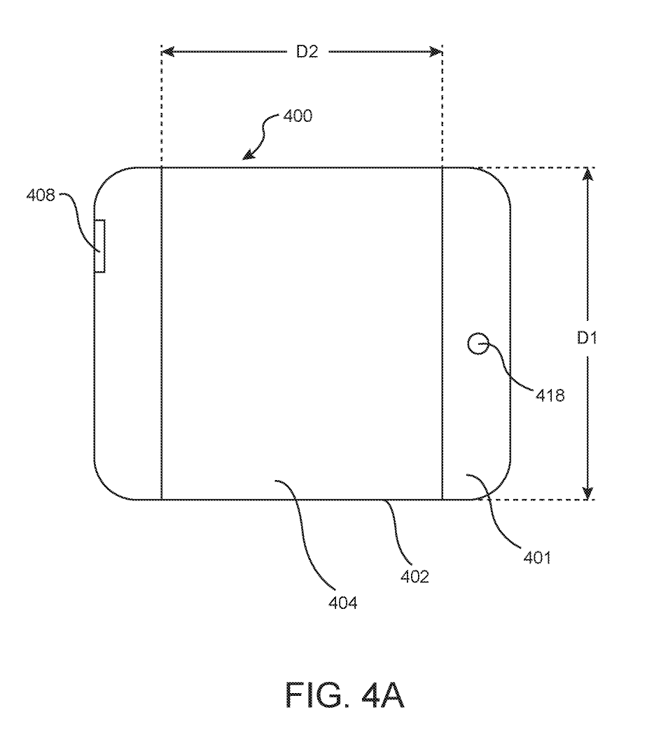

Referring to FIG. 4A, a front side of a wireless device 400 constructed in accordance with as aspect of this disclosure is illustrated. Likewise, FIG. 4B shows a back side of the wireless device 400. In particular, the wireless device 400 according to an aspect of the disclosure includes a housing 401 and a display 402. The display 402 can be any type of display including LCD, LED, VGA, OLED, SVGA and other types of displays that may include touch sensitive screen displays. The display 402 may be a colored, non-colored (e.g. gray scale) or a combination of both. The display 402 can display information such as the make, model, year of vehicles (e.g., the vehicle 100), the baseline data of the vehicle components 110(1)-110(n) in the vehicle 100, part images, parts information, and information from remote servers (internet, database information, etc.). Additionally, the display 402 can show videos for the technician to view and the accompanying audio can be heard via speakers 414. The speakers 414 can be a single speaker or multiple speakers for stereo sound. A function button 418 may arranged on the housing 401 and may be configured to provide different input functionalities. Additionally, a power button 408 may be arranged on the housing 401 and may operate to turn on or turn off the wireless device 400. In one embodiment, the display 402 allows the technician to input selection through a touch screen for interactive navigation and selection, wherein the technician can select a menu item by touching the selection on the screen 404. By way of example only and not by way of limitation, the wireless device 400 may be a personal computer, a tablet computer, a laptop, a mobile phone, or the like.

A camera 406 may include or may be operatively coupled to an image sensor 501 of the wireless device 400 and configured to obtain an image input (e.g., an image of the hood of the vehicle 100 in FIG. 1), and to record still images or video. The camera 406 includes a lens or as many as needed, and a flash 416. Lens zoom and focus features may also be included in the wireless device 400 and may be digitally enhanced by software in the wireless device 400.

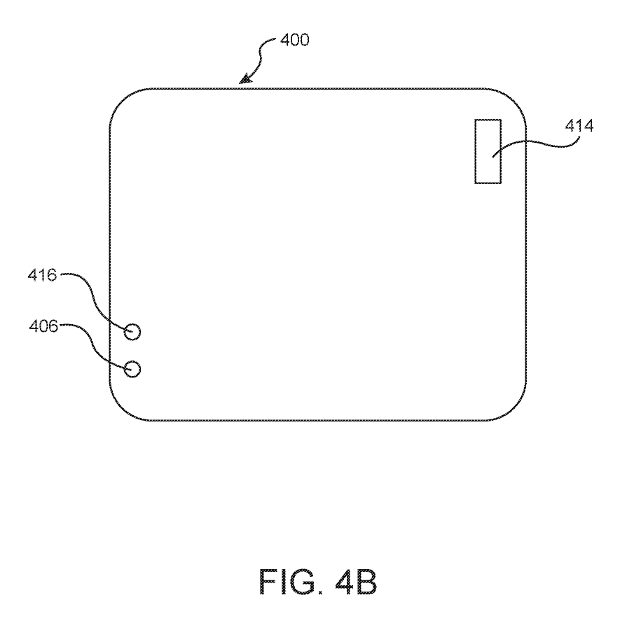

In one aspect, the technician can use the camera 406 to take a picture of the vehicle 100 or a part thereof. A database 512 (shown in FIG. 5) stored on the wireless device 400 or remotely can be used to identify the vehicle 100 by using image recognition software. The database 512 can contain images or other identifying characteristics of the vehicle 100. Certain portions (identifying points and measurements) or the whole profile of the vehicle 100 can be used to compare the vehicle 100 to images of vehicles stored in the database 512. The image recognition software may use various characteristics of the vehicle 100 to conduct a search using the database 512. These characteristics include measurements of the vehicle 100, surface characteristics of the vehicle 100, identifying engravings on a body or a part of the vehicle 100, etc. Once the search identifies the vehicle 100, the information related to the vehicle 100 can be displayed on the display 402 of the wireless device 400 for verification by the technician.

In another aspect, the technician can use the camera 406 to take a picture of one or more of the wire looms 102, 104, 106, and/or 108, as well as the vehicle components 110(1)-110(n). The database 512 stored on the wireless device 400 or remotely can be used to identify the wire looms 102, 104, 106, and/or 108, and the vehicle components 110(1)-110(n) by using image recognition software. The database 512 can contain images of various parts of the vehicle 100, including the wire looms 102, 104, 106, and 108 and the vehicle components 110(1)-110(n), or other information such as bar code information, etc. Certain portions (identifying points and measurements) or the whole profile of the wire looms 102, 104, 106, and/or 108, and the vehicle components 110(1)-110(n) can be used to compare the part to images of parts of the vehicle 100 stored in the database 512. The image recognition software may use various characteristics of the wire looms 102, 104, 106, and/or 108 to conduct the search. These characteristics include measurements of the wire looms 102, 104, 106, and/or 108, wiring, connections, color(s), contrast (the wire looms 102, 104, 106, and/or 108 versus the background of the vehicle 100), surface characteristics of the wire looms 102, 104, 106, and/or 108 (e.g., number and spacing of surface grooves, length, thickness), vehicle component shapes, sizes, electrical and mechanical characteristics, names, makes, types, etc.

Once the search identifies the wire looms 102, 104, 106, and/or 108 and/or the vehicle 100, the information related to the wire looms 102, 104, 106, and/or 108 and/or the vehicle can be displayed on the display 402 of the wireless device 400 for verification by the technician. The information can include a part number of the wire looms 102, 104, 106, and/or 108, diagrams on how to remove and replace the wire looms 102, 104, 106, and/or 108, diagrams on where the wire looms 102, 104, 106, and/or 108 are located on the vehicle 100, manuals for the wire looms 102, 104, 106, and/or 108, specifications about the wire looms 102, 104, 106, and/or 108, warranty information, OEM (original equipment manufacturer) equivalent parts, etc., and likewise for the vehicle components 110(1)-110(n). Once properly identified, additional information such as parts availability, pricing, location, etc. may be retrieved.

In some scenarios, the technician may be able to access the schematic wiring diagram 300 on a screen 404 of the display 402 a wireless device 400 shown in FIG. 4A. However, the screen 404 has dimensions D₁ and D₂ that limit the amount of information that may be displayable. When the schematic wiring diagram 300 is displayed on the screen 404, the technician still has to visually correlate the vehicle components 110(1)-110(n) and connections thereof with lines shown in the schematic wiring diagram 300. Typically, in conventional techniques, as presented on the display 402, the schematic wiring diagram 300 is static. That is, once presented on the display 402, the schematic wiring diagram 300 does not change with respect to how the electrical connectors 304 and/or the wire drawings 306 are shown on the display 402. The technician may use his/her fingers to view different portions of the schematic wiring diagram 300.

In some other scenarios, such as those disclosed in U.S. Pat. No. 7,636,622 (the '622 patent), owned entirely by the current Applicant of this patent application, and incorporated herein by reference in its entirety, the schematic wiring diagram 300 may include some of the wire drawings 306 shown as the highlighted wires 308. At most, the highlighted wires 308 may be show as blinking on the display 402, as also disclosed in the '622 patent. As will be appreciated by one of ordinary skill in the art, such blinking of the highlighted wires 308 still does not help the technician get a replica of what the technician views under the hood of the vehicle 100 (or anywhere else on/in the vehicle 100), and the technician needs to look back and forth between what is presented on the display 402 and what he/she views as the wire looms 102, 104, 106, and/or 108 in FIG. 1. Furthermore, the schematic wiring diagram 300 provides no indication or visualization of any fault locations and/or what depth one or more of the wire looms 102-108 (where such a fault may exist) have to be cut to get to the wires 202(1)-202(m). Here too, the technician has to rely on his/her experience or a guess of how deep the wire locations inside the wire looms 102-108 are to get to a faulty wire or connection.

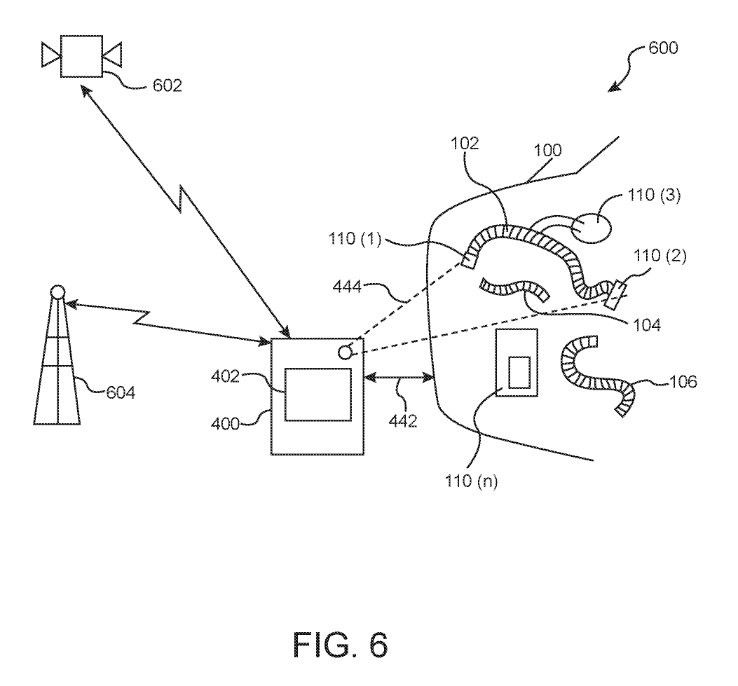

Accordingly, various aspects of this disclosure allow for a comfortable viewing of an actual connection of the wires 202(1)-202(m) in the vehicle 100 relative to a position thereof in the vehicle 100 and with respect to the vehicle components 110(1)-110(n). Further various aspects of this disclosure provide a realistic three-dimensional (3D) view of the wire looms 102, 104, 106, and/or 108 as viewed in FIG. 1. In one aspect, using the wireless device 400, the technician can go on a “journey” following a wire or a harness (e.g., the wire 202(1) inside the wire loom 102) through the vehicle 100 using the wireless device 400. An interactive wiring diagram 700 (shown in FIG. 7) is presented on the display 402 and includes visual and/or audible location services for connectors, splices, grounds, etc., for the wires 202(1)-202(m) of the wire loom 102, for example. Unlike traditional wiring diagrams (e.g., the schematic wiring diagram 300) that are massive, often printed on sheets of paper, and are shown as schematics that are difficult to read given the dimensions D₁ and D₂ of the display 402, the interactive wiring diagram 700 reflects an actual wiring viewed by the technician inspecting the vehicle 100.

Referring to FIG. 5, a block diagram of parts of the wireless device 400 according to an aspect of the invention. In FIG. 5, the wireless device 400 includes the camera 406 having the image sensor 501 (e.g., a charge coupled device (CCD)), a processor 502, the display 402, an input device in the form of a touchscreen and/or a keypad 504, a memory 508, and the database 512, and a wireless communication circuit 538.

The wireless device 400 may include a field programmable gate array (FPGA) 514, a first system bus 524, a complex programmable logic device (CPLD) 506, a card reader 520, a second system bus 522, a connector interface 511, a selectable signal translator 510, a position sensor 540 including an antenna 532, a receiver 534, and an altimeter 536. In one aspect, in addition to or instead of the FPGA 514, the wireless device may include an application specific integrated chip (ASIC) to have functionality similar to the FPGA 514, as discussed herein.

A vehicle communication interface 530 of the vehicle 100 may be in communication with the wireless device 400 through a connector interface 511 via an external cable, or via a wireless connection with the vehicle 100. The selectable signal translator 510 may communicate with the vehicle communication interface 530 through the connector interface 511. The signal translator 510 may condition signals received from an electronic control unit (ECU) through the vehicle communication interface 530 to a conditioned signal compatible with wireless device 400. The signal translator 510 can communicate with, for example, the following communication protocols: J1850 (VPM and PWM), ISO 9141-2 signal, communication collision detection (CCD) (e.g., CHRYSLER® collision detection), data communication links (DCL), serial communication interface (SCI), Controller Area Network (CAN), Keyword Protocol 2000 (ISO 14230-4), OBD II or other communication protocols that are implemented in the vehicle 100.

Alternatively, the wireless device 400 may communicate with the vehicle utilizing wireless technology consistent with of U.S. patent application Ser. No. 13/155,961, entitled, “Cellular Phone Configured with Off-Board Device Capabilities and Starter/Charger and Battery Testing Capabilities,” filed Jun. 8, 2011, now U.S. Pat. No. 8,180,515, issued on May 15, 2012, the description of which is incorporated herein by reference in its entirety and owned entirely by the Applicant of this patent application.

The circuitry to translate and send in a particular communication protocol can be selected by the FPGA 514 (e.g., by tri-stating unused transceivers) or by providing a keying device that plugs into the connector interface 511 that is provided by the wireless device 400 to connect the wireless device 400 to the vehicle communication interface 530. The signal translator 510 may also be coupled to the FPGA 514 and the card reader 520 via the first system bus 524. The FPGA 514 transmits to and receives signals (i.e., messages) from the ECU through the signal translator 510 and/or the processor 502. Alternatively, an ASIC protocol may be used to implement the communications to and from the ECU through the signal translator 510 and/or the processor 502.

The FPGA 514 may be coupled to the processor 502 through various address, data and control lines implemented by the second system bus 522. The FPGA 514 may also be coupled to the card reader 520 through the first system bus 524. The processor 502 may be also coupled to the display 402 in order to output the desired information to the technician. The processor 502 may communicate with the CPLD 506 through the second system bus 522.

Additionally, the processor 502 may be programmed to receive input from the technician through the keypad 504 via the CPLD 506. The CPLD 506 provides logic for decoding various inputs from the user of the wireless device 400 and also provides glue-logic for various other interfacing tasks.

The memory 508 and the internal non-volatile memory 518 may be coupled to the second system bus 422, which allows for communication with the processor 502 and the FPGA 514. The memory 508 can include an application dependent amount of dynamic random access memory (DRAM), a hard drive, and/or read only memory (ROM). The software to run the wireless device 400 can be stored in the memory 508 or the internal non-volatile memory 518, including any other database(s).

In one aspect, the vehicle 100 and the database 512 can be located on a remote computing device instead of being local on the wireless device 400. When remote, the database 512 can be accessed via a wireless or wired connection. The database 512 may be stored on an external memory, such as a compact flash card or other memories and accessed locally by the diagnostic tool.

The internal non-volatile memory 518 can be an electrically erasable programmable read-only memory (EEPROM), flash ROM, or other similar memory. The internal non-volatile memory 518 can provide, for example, storage for boot code, self-diagnostics, various drivers and space for FPGA images, if desired. If less than all of the modules are implemented in the FPGA 514, the internal non-volatile memory 518 can contain downloadable images so that the FPGA 514 can be reconfigured for a different group of communication protocols.

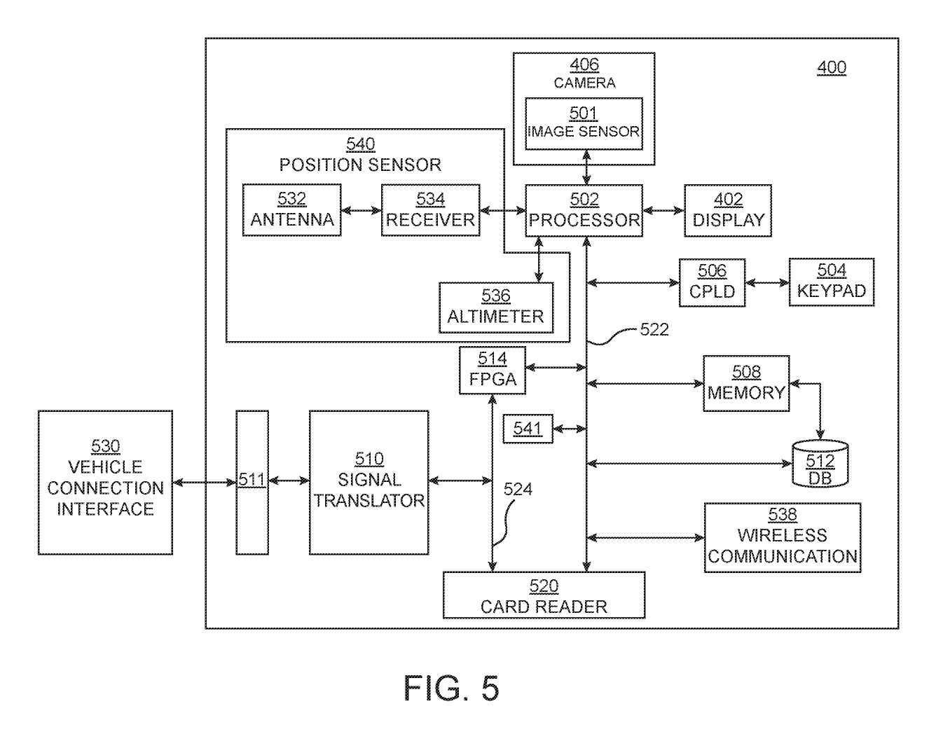

The antenna 532 and the receiver 534 may be mounted in or on the housing 401. The antenna 532 electronically couples to the receiver 534 and allows the receiver 534 to communicate (detect and decode signals) with one or more satellites 602 (shown in FIG. 6) that orbit the Earth. In one aspect, the antenna 532 and the receiver 534 may be a single Global Positioning System (GPS) device included as part of the position sensor 540. Further, the position sensor 540 may include an inertial measurement unit (IMU) and the altimeter 536 in addition to the antenna 532 and the receiver 534. The receiver 534 and antenna 532 may electronically couple to the processor 502, which is coupled to the memory 508, the NVM 518 or a memory card in the card reader 520. The memories can be used to store cartographic data, such as electronic maps. The wireless device 400 can include all the maps for the U.S. (or country of use), North America or can have the region or state where the wireless device 400 is located.

The receiver 534 communicates with and “locks on” to a certain number of the satellites 602 in order to have a “fix” on its global location. Once the location is fixed, the receiver 534, with the help of the processor 502, can determine the exact location including longitude, latitude, altitude, and velocity of movement and other navigational data of the wireless device 400. Should the receiver 534 be unable to lock onto the minimum number of satellites to determine the altitude or unable to determine the altitude for any reason, the altimeter 536 can be used to determine an altitude of the wireless device 400. The altimeter 536 is electronically coupled to the processor 502 and can provide the altitude or elevation of the wireless device 400. The altimeter 536 can be coupled to a barometric pressure sensor (not shown) in order to calibrate the elevation measurements determined by the altimeter 536. The position sensor 540 can be positioned interior or exterior to the housing 401 of the wireless device 400. Minor atmospheric pressure changes can affect the accuracy of the altimeter 536. Thus, the wireless device 400 can correct for these changes by using the position sensor 540 in conjunction with the altimeter 536 along with a correction factor.

The wireless communication circuit 538 may communicate with the processor 502 via the second bus system 522. The wireless communication circuit 538 can be configured to communicate via RF (radio frequency), the one or more satellites 602, cellular phones (analog or digital), Bluetooth™, Wi-Fi, Infrared, Local Area Networks (LAN), WLAN (Wireless Local Area Network), other wireless communication channels, configurations and standards or a combination thereof. The wireless communication circuit 538 allows the diagnostic tool to communicate with other devices wirelessly such as with a remote computing device having remote databases. The wireless communication circuit 538 may further include an antenna built therein and being housed within the housing 401 or can be externally located on the housing 401.

The database 512 may contain detailed information on various vehicles. The information may include schematics, wiring systems, internal and external images, fuel systems, electronic modules and the like. The information may identify vehicles by vehicle year, vehicle model, vehicle identification number or any other identifying information. The database 512 may be stored within the wireless device 400, stored partially within the wireless device 400, and/or stored external to the wireless device 400 in a separate database that may be accessed via the Internet or the like as described above.

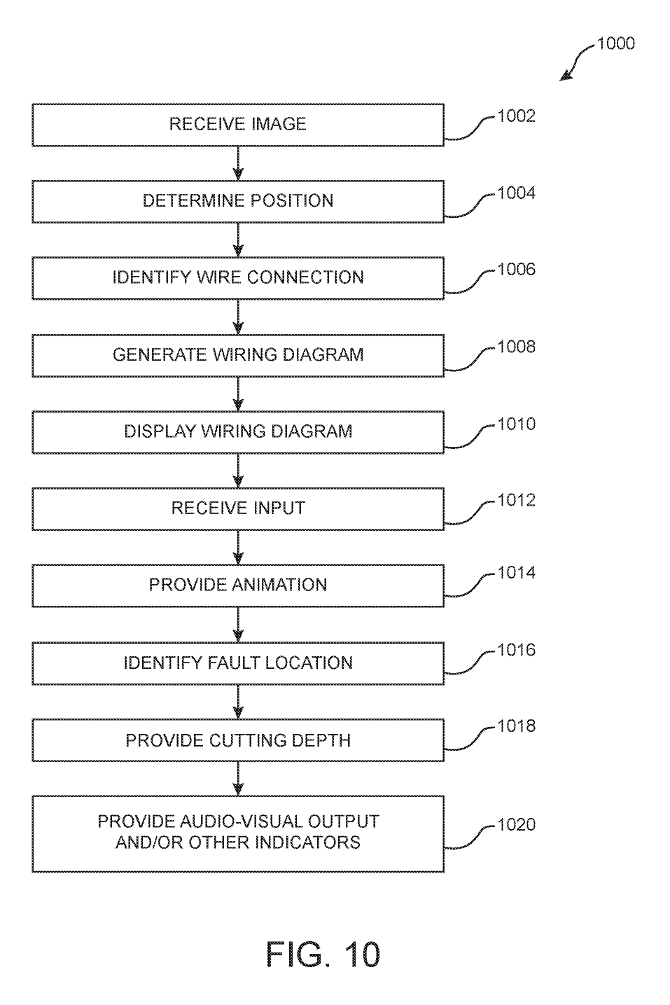

The processor 502 may execute instructions and other computer programs in order to operate the wireless device 400 described herein, e.g., according to a method 1000 discussed with respect to FIG. 10. Additionally, the processor 502 may execute any other functions necessary to operate peripheral devices and other aspects not necessarily associated with this disclosure.

The wireless device 400 may further include an orientation circuit 541. The orientation circuit 541 may include an inertial sensor including, for example, various strain gages and load transducers to determine an orientation of the wireless device 400. This allows the wireless device 400 to determine and provide an orientation, movement direction or change in both to the processor 502.

In operation, the wireless device 400 may allow a service technician to select a vehicle for which to obtain information. Additionally or alternatively, the wireless device 400 may be able to identify the vehicle 100 based on the vehicle 100's image obtained by the wireless device 400 as an image input (e.g., as a photograph captured by the camera 406). In this regard, the processor 502 may compare the image to other images that are stored in the database 512. Based on this comparison, the processor 502 may select the vehicle type in the database 512 based on this comparison process and provide the service technician detailed schematics as well as the interactive wiring diagram 700 (as discussed with respect to FIGS. 7-10) from the database 512.

Once an identification of the vehicle 100 is established via any of the processes described herein, detailed positioning image data within the vehicle model is possible through recognition of the field of view of the wireless device 400 as the technician moves the wireless device 400 and camera 406 around the vehicle 100. In other words, the image displayed by the wireless device 400 on the display 402 that is captured by the camera 406, may move and change with the movement of the wireless device 400. The moving image may be based on the change in position of the outline of the vehicle image as captured by the camera 406, may be based on the orientation circuit 541 output, may be based on change a position as determined by the position sensor 540 or may be based on other types of data. The schematic data and the like may be superimposed on the image of the vehicle 100 on display 402 and may move on the display 402 as the image of the vehicle 100 moves.

Referring to FIG. 6, a system 600 for providing the interactive wiring diagram 700 is illustrated, in accordance with an aspect of this disclosure. The system 600 includes the vehicle 100 and the wireless device 400 at a position 442 relative to the vehicle 100. In one aspect, the system 600 may, additionally or optionally, include the one or more satellites 602 and one or more communication repeaters 604 in wireless communication with the wireless device 400 and/or the vehicle 100.

The position 442 of the wireless device 400 is determined by the position sensor 540 in the wireless device 400. Although the position 442 in FIG. 6 is generally illustrated relative to an end of the vehicle 100, it will be appreciated that the position sensor 540 may be used to determine a relative distance or relative position between the wireless device 400 and the plurality of wire looms 102, 104, 106, 108 and/or the vehicle components 110(1)-110(n). In one aspect, the position sensor 540 may be configured to determine where within the vehicle 100, each of the plurality of wire looms 102, 104, 106, 108 is located. Such position information or location information of the vehicle 100, the plurality of wire looms 102, 104, 106, 108, and/or the vehicle components 110(1)-110(n) provided by the position 442 may be used by the wireless device 400 to identify the vehicle 100, the plurality of wire looms 102, 104, 106, 108, and/or the vehicle components 110(1)-110(n). For example, based upon the position 442 of the wire loom 102, the wireless device 400 may determine that the wire loom 102 includes connections between the ECU and the engine of the vehicle 100. In another example, the wireless device 400 may utilize the position 442 to provide a list of probable connections that may be present in a location where the wire loom 102 is detected as present by the wireless device 400. In another aspect, based upon an image 444 of the wire loom 102 obtained by the image sensor 501 of the camera 406, the wireless device 400 may identify the wire loom 102 and the plurality of wire connections 202 therein, including the plurality of wires 202(1)-202(m). In yet another aspect, the processor 502 of the wireless device 400 may utilize both the position 442 and the image 444 of the wire loom 102 to identify the wire loom 102 and one or more of the plurality of wire connections 202 therein, as implemented using the wires 202(1)-202(m).

In one aspect, the image 444 of the wire loom 102 may include an image of a first vehicle component 110(1) and a second vehicle component 110(n) at each end of the wire loom 102. It will be appreciated by one of ordinary skill in the art in view of this disclosure that the image 444 may include other ones of the plurality of wire looms 104, 106, and/or 108, and likewise, other ones of the vehicle components 110(3)-110(n), and the discussion herein with respect to the wire loom 102, the first vehicle component 110(1) and the second vehicle component 110(2) is by way of example only and not by way of limitation. For example, the first vehicle component 110(1) may be a throttle position sensor and the second vehicle component 110(2) may be the ECU of the vehicle 100. Further, the image 444 may include additional intermediary vehicle components (if and when visible), including but not limited to splices, connectors, ground points, etc.

In the system 600, the processor 502 may communicate with the memory 508 including processor executable instructions, which when executed by the processor 502 cause the processor 502 to carry out the various features and functionalities of the aspects of this disclosure, for example, those discussed with respect to FIGS. 6-10.

Referring to FIG. 7, the interactive wiring diagram 700 as presented on the display 402 of the wireless device 400 is illustrated, according to an exemplary aspect of this disclosure. The image 444 obtained by the wireless device 400 is presented on the display 402 as the interactive wiring diagram 700 including a wire loom image 102′ of the wire loom 102. The wire loom image 102′ is displayed with the first vehicle component image 110(1)′ and the second vehicle component image 110(2)′. The interactive wiring diagram 700 is “interactive” in the sense that a graphical user interface (GUI) 704 is provided on the display 402 for the technician viewing the wire loom 102 to animate the wire loom image 102′ display to move, starting from viewing the first vehicle component image 110(1)′ and ending at the second vehicle component image 110(2)′. In this respect, the first vehicle component image 110(1)′ and the second vehicle component image 110(2)′ form a starting point and an end point of the interactive wiring diagram 700, although such starting point and end point could be anywhere along the wire loom image 102′.

In addition to the wire loom image 102′, a trace route 706 is also displayed on the display 402. The trace route 706 includes wire traces 708 identifying the plurality of wire connections 202 corresponding to the wires 202(1)-202(m) within the wire loom 102. Further, the processor 502 upon identifying one or more of the plurality of wire connections 202, e.g., using the database 512 based upon the image 444 and/or the position 442, is configured to display a third vehicle component image 702 between the first vehicle component image 110(1)′ and the second vehicle component image 110(2)′. The third vehicle component image 702 corresponds to a third vehicle component in the vehicle 100 present on the wire loom 102 in between the first vehicle component 110(1) and the second vehicle component 110(2). For example, the third vehicle component image 702 may correspond to a splice, a connector, or a ground point. Accordingly, the trace route 706 may convey information to the technician using the wireless device 400 that wire traces 708, as shown, connect the first vehicle component image 110(1)′ to the second vehicle component image 110(2)′ via the third vehicle component image 702, indicating that in reality, the wire loom 102 connecting the first vehicle component 110(1) to the second vehicle component 110(2) goes through a third vehicle component (e.g., a splice).

The technician may interact with the interactive wiring diagram 700 via the trace route 706 using the GUI 704. In one aspect, the GUI 704 may include a rewind icon 704a, a stop icon 704b, a play icon 704c, a pause icon 704d, a forward icon 704e, a zoom-in icon 704f, a zoom-out icon 704g, and/or a map point selection icon 704h, displayed in suitable geometrical shapes, such as the exemplary shapes shown in the GUI 704. The interactive wiring diagram 700 may initially be generated by the processor 502 and presented on the display 402 showing a complete image of the wire loom 102 displayed as the wire loom image 102′. The interactive wiring diagram 700 may include the trace route 706 illustrating the complete wire connection between the first vehicle component 110(1) and the second vehicle component 110(2) on the display 402.

However, the processor 502 may receive an input on the trace route 706 specifying the starting point and the end point to view as the interactive wiring diagram 700 using the map point selection icon 704h. For example, the map point selection icon 704h may be dragged and dropped onto the starting point of the trace route 706 by sliding the map point selection icon 704h from the GUI 704 onto the starting point on the trace route 706 desired to be selected by the technician. Likewise, the map point selection icon 704h may be subsequently dragged and dropped onto the ending point on the trace route 706. Since the trace route 706 was previously generated by the processor 502 from the image 444 of the wire loom 102 and/or the position 442 provided by the position sensor 540 to the processor 502, the trace route 706 provides all components and connectors present in the wire loom 102 on the trace route 706. The processor 502 may then receive another input to select only a particular wire connection in the wire loom 102. Accordingly, the interactive wiring diagram 700 may be generated and displayed by the processor 502 for only the selected wire connection from the trace route 706.

In one aspect, the interactive wiring diagram 700 and/or the trace route 706 may be scalable as displayed on the display 402. The zoom-in icon 704f and the zoom-out icon 704g may be selected by the technician, and the processor 502 may detect such a selection to obtain a larger or smaller image of the interactive wiring diagram 700 on the display 402. Alternatively, the processor 502 may be able to detect gesture-based inputs from the technician to change a scale of display of the interactive wiring diagram 700.

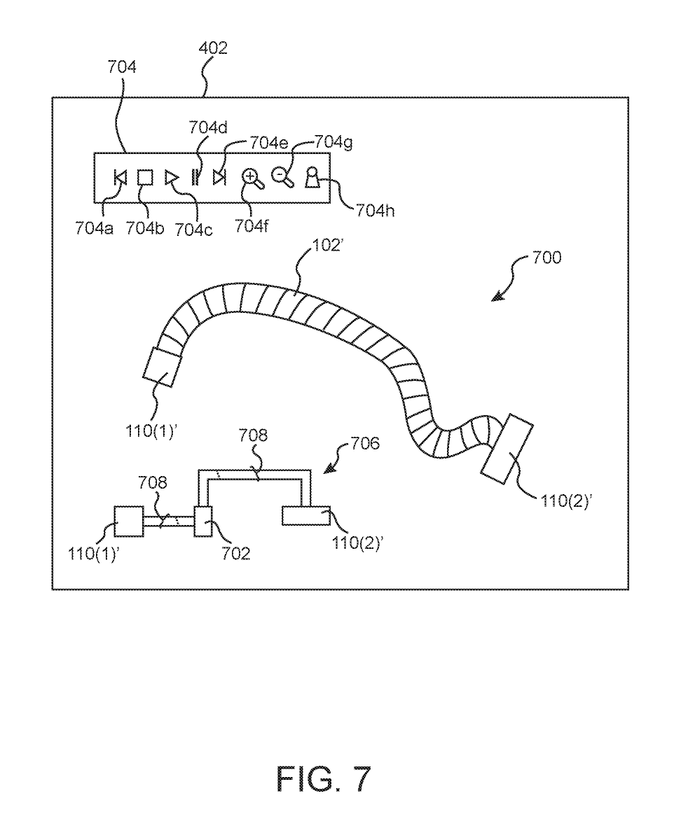

Referring to FIG. 8, according to one aspect of this disclosure, the interactive wiring diagram 700 may provide an animation of a cutting depth 802 of the wire loom 102. The cutting depth 802 informs the technician of a depth that the wire loom 102 needs to be cut to diagnose a fault location. For example, such a fault location may be at the third vehicle component illustrated on the wire loom image 102′ by the third vehicle component image 702 (shown superimposed on the wire loom image 102′ in FIG. 8). The cutting depth 802 may be provided as a visual numerical value on the display 402 and/or as an audio output via the speaker 414 of the wireless device 400. The processor 502 may obtain the value of the cutting depth 802 from the database 512 upon the identification of the wire loom 102. Although not explicitly illustrated in FIG. 8, the processor 502 may illustrate the cutting depth 802 at other points in the wire loom 102, anywhere between the first vehicle component 110(1) and the second vehicle component 110(2), e.g., based upon inputs received by the processor 502 from the technician. Indication of the cutting depth 802 is advantageous as the technician knows exactly how far to cut into the wire loom 102, and accordingly, overcutting of the wire loom 102 is avoided.

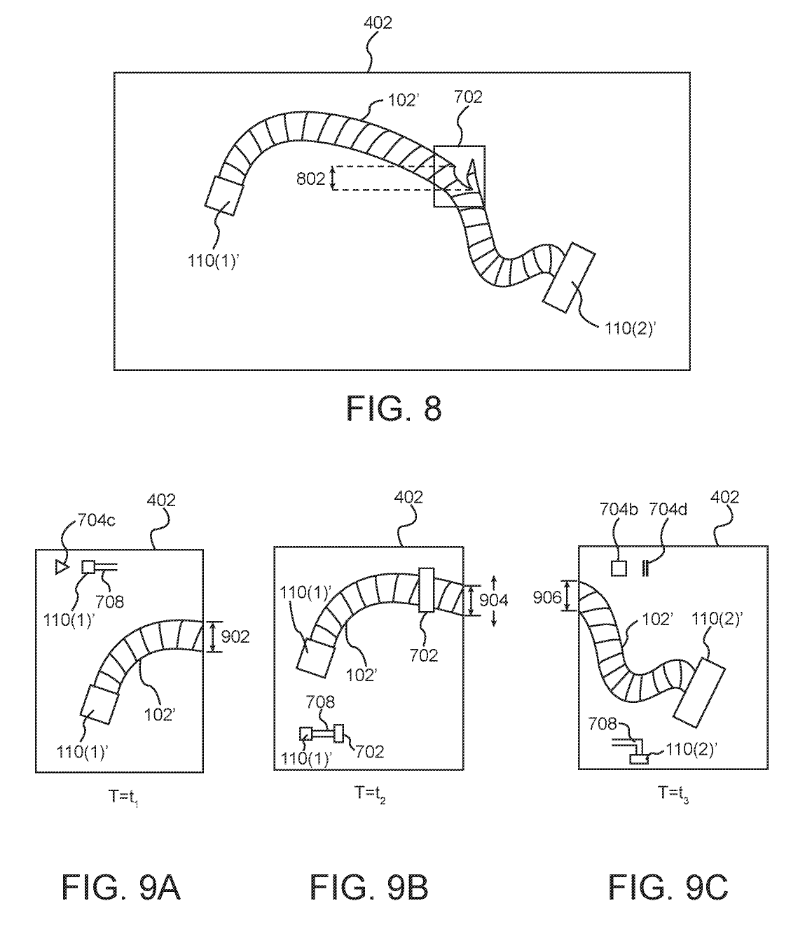

Referring back to FIG. 7, until the processor 502 receives an input for the play icon 704c, the interactive wiring diagram 700 is constant in display, except for the changes to scale made using the zoom-in icon 704f and the zoom-out icon 704g. When the processor 502 receives an input corresponding to the play icon 704c, the processor 502 is configured to provide an animation of the wire loom image 102′, as illustrated with reference to FIGS. 9A, 9B, and 9C. Such animation is provided after the technician provides the starting point and the end point on the trace route 706. A “journey” along the wire loom 102 is then defined as the animation of the wire loom image 102′ showing how the wire loom 102 would be visible if a person were to move from the starting point to the end point on the wire loom 102, with one or more points in between the starting point and the end point on the wire loom 102 that may be viewed in detail to identify a fault location.

For example, in FIG. 9A, at a time instance t₁, the processor 502 may receive an input of the play icon 704c, and may start showing a portion of the trace route 706 on the display 402 including the first vehicle component 110(1)′ and a part of the wire traces 708. Likewise, at the same time instant t₁, the processor 502 may show what the displayed portion of the trace route 706 may look like at the corresponding portion of the wire loom image 102′, shown at a first scale 902. As illustrated in FIG. 9A, the journey at the time instant t1 includes the first vehicle component 110(1)′ and a part of the wire loom image 102′.

Moving on to FIG. 9B, at a time instant t₂, the journey continues to display the third vehicle component image 702 on the trace route 706, and correspondingly on the wire loom image 102′, displayed at a second scale 904. Likewise, moving on to FIG. 9C, at a time instant t₃, the journey ends when the end point in the trace route 706 is reached (in this example, the end point being the second vehicle component image 110(2)′). In FIG. 9C, the wire loom image 102′ may be viewed at a third scale 906. In one aspect, two or more of the first scale 902, the second scale 904, and the third scale 906 may be equal. Alternatively, two or more of the first scale 902, the second scale 904, and the third scale 906 may be unequal. Each of the first scale 902, the second scale 904, and the third scale 906 indicates a particular size of the wire loom image 102′ suitable for comfortable viewing on the display 402 by the technician.

During the animation illustrated using FIGS. 9A-9C, the processor 502 at any time may receive an input corresponding to the stop icon 704b to stop the animation or to pause the animation using the pause input 704d. For example, the technician viewing the animation may want to spend more time viewing the fault location (e.g., at the third vehicle component image 702), and may pause the animation. The animation may be resumed using the play icon 704c. It will be appreciated that although FIGS. 9A-9C show three time instants t₁, t₂, and t₃, the animation may be viewed using a higher or lower number of time instants. Further, instead of the wire loom image 102′, the animation may include visualization of one or more of the plurality of wires 202(1)-202(m). The animation may be replayed or a speed of playing the animation may be controlled. Furthermore, the animation may include other vehicle components 110(3)-110(n) shown as corresponding images in the background of the wire loom image 102′ to provide a realistic view of the image 444 obtained by the wireless device 400 and viewed by the technician (e.g., as seen under a hood of the vehicle 100 in FIG. 1).

Referring to FIG. 10, the method 1000 for providing the interactive wiring diagram 700 on the wireless device 400 is illustrated as a flowchart, in accordance with an aspect of this disclosure. FIG. 10 presents the method 1000 as a flow diagram, although the method 1000 may be understood using other types of presentations such as process diagrams, graphs, charts, timing diagrams, etc. In one aspect, one or more processes or operations in the method 1000 may be carried out by the processor 502 of the wireless device 400. The method 1000 may at least partially be implemented by executing the computer executable instructions stored in the memory 508 of the wireless device 400.

The method 1000 may begin in an operation 1002, the wireless device 400, at the processor 502, receives from the image sensor 501 of the wireless device 400, the image 444 of the wire loom 102 between the first vehicle component 110(1) and the second vehicle component 110(2) of the vehicle 100. As discussed, the wire loom 102 includes the plurality of wire connections 202 implemented by the plurality of wires 202(1)-202(m). The image 444 may be obtained at the processor 502 by the technician working on the vehicle 400 positioning the wireless device 400 to an appropriate spot. It will be appreciated that the wireless device 400 may be utilized to obtain a plurality of images similar to the image 444 for different parts of the vehicle 100 and the image 444 of the wire loom 102 is by way of example only and not by way of limitation. The image 444 may be obtained by turning on the camera 406 of the wireless device 400 and activating a hardware or a software interface (not shown) on the wireless device 400 to obtain the image 444 once the camera 406 is appropriately positioned. The image 444 is captured by the image sensor 501 of the camera 406 and forwarded to the processor 502 for processing and storage in the memory 508, for example, although the image 444 may be stored elsewhere (e.g., remotely from the wireless device 400 using a wireless communication channel with a remote storage).

In one aspect, the image 444 may include parts of the plurality of wires 202(1)-202(m), when the plurality of wires 202(1)-202(m) are partially exposed. Alternatively, the image 444 may not directly show individual ones of the plurality of wires 202(1)-202(m) of the wire loom 102. Further, the image 444 may include additional components including but not limited to a third vehicle component between the first vehicle component 110(1) and the second vehicle component 110(2), as well as other components surrounding the wire loom 102. Still further, the image 444 of the wire loom 102 may include identifying information on the wire loom 102, such as Quick Response (QR) codes or bar codes from a tag (not shown) attached to the wire loom 102, which are recognizable by the processor 502 using the database 512.

In an operation 1004, the wireless device 400 determines, using the position sensor 540 of the wireless device 400, the position 442 of the wire loom 102 relative to the vehicle 100 and to the wireless device 400. The position sensor 540 may communicate with the one or more satellites 602 to determine the position 442, using, for example, triangulation techniques. Alternatively or additionally, the wireless device 400 may determine an elevation of the wireless device 400 using the altimeter 536 and/or an orientation of the wireless device 400 using the orientation circuit 541 to determine accurately the position 442 of the wireless device 400 relative to the vehicle 100.

In an operation 1006, the processor 502 of the wireless device 400 may identify one or more of the plurality of wire connections 202 based upon at least the image 444 or the position 442 of the wire loom 102, or both the image 444 and the position 442 of the wire loom 102. For example, the image 444 may provide physical characteristics to the processor 502 including but not limited to a length, thickness, a number of turns, a number of grooves, a color, an engraving on the wire loom 102, a tag with a bar code or a QR code, and the like, or combinations thereof. The processor 502 may communicate with the database 512 to match the information extracted from the image 444 to identify the wire loom 102 and/or one or more of the plurality of wire connections 202 therein. Standard image recognition and processing, filtering, and noise removal techniques may be implemented within the processor 502 to perform the identification of the wire loom 102 in the operation 1006.

Likewise, still in the operation 1006, the processor 502 may identify the wire loom 102 based upon the position 442 of the wire loom 102. For example, the processor 502 may determine that the wire loom 102 is present in a front part of the vehicle 100 and may therefore identify the wire loom 102 as being associated with the hood of the vehicle 100 and not an exhaust system of the vehicle 100. Further, the processor 502 may determine the position 442 of the wire loom 102 with respect to the vehicle components 110(1)-110(n) and identify the wire loom 102 as a connection between specific ones of the vehicle components 110(1)-110(n), e.g., the first vehicle component 110(1) and the second vehicle component 110(2). Furthermore, the position 442 may be used by the processor 502 to make a probabilistic determination of the identification of the wire loom 102. For example, the processor 502 may determine from the position 442 that the wire loom 102 has a high probability of being a connection between the engine and a throttle position sensor, and accordingly query the database 512 to identify the wire loom 102. Such querying may be carried out, for example, using a sequential querying language and associated code, resident on the memory 508 accessed by the processor 502. The processor 502 may also verify the identification based upon the position 442 using the image 444, and vice versa.

In an operation 1008, the processor 502 may generate the interactive wiring diagram 700 based upon the identification of the wire loom 102. The interactive wiring diagram 700 may be generated to include the trace route 706, also generated by the processor 502. The trace route 706 may be a representation of one or more of the plurality of wire connections 202 in a schematic format (similar to the schematic wiring diagram 300). The processor 502, upon identification of the wire loom 102 may obtain additional information regarding the wire loom 102 from the database 512. Such information may include, but is not limited to, an image of the wire loom 102, identifying characteristics of the wire loom 102 such as a number of the plurality of wires 202(1)-202(m), individual connection schemes for the plurality of wires 202(1)-202(m) to be used for generation of the trace route 706 as well as for the generation of the interactive wiring diagram 700, and surrounding environment of the wire loom 102, and the like, or combinations thereof. Further, such information may be used to include additional vehicle components, e.g., splices, connectors, ground points, etc., present in the wire loom 102 but not directly visible in the image 444. For example, FIGS. 7, 8, 9A, 9B, and 9C show the third vehicle component (as the third vehicle component image 702) present between the first vehicle component image 110(1)′ and the second vehicle component image 110(2)′, which third vehicle component was not visible to the technician in FIG. 1, and in fact may include a fault location (e.g., as shown in FIG. 8).

In an operation 1010, the processor 502 is configured to display the interactive wiring diagram 700 on the display 402, as illustrated for example, in FIGS. 7, 8, and 9A-9C. In one aspect, the display 402 may display the wire loom image 102′ along with the trace route 706 generated in the operation 1008. Alternatively, the display 402 may not display the trace route 706. Yet alternatively, the display 402 may display the interactive wiring diagram 700 along with the surrounding components viewed in the image 444 when the wireless device 400 is brought near the vehicle 100 and the image 444 is captured. As a result, the technician viewing the display 402 in the operation 1010 may see a replica of what is viewed by the technician via the wireless device 400, for example, under the hood of the vehicle 100 in FIG. 1.

In an operation 1012, the processor 502 may receive an input specifying a starting point and an end point in the trace route 706 displayed on the display 402. Alternatively, the input received by the processor 502 may be on the interactive wiring diagram 700 instead of the trace route 706. For example, the technician may provide an input to select any point as the starting point on the wire loom image 102′ using the map point selection icon 704h. The map point selection icon 704h may be dragged and dropped on the interactive wiring diagram 700 and/or the trace route 706. Such dragging and dropping may also for a part of the input received as the processor 502. Such dragging and dropping of the map point selection icon 704h may begin a “journey” on the wire loom image 102′.

In the operation 1014, the processor 502, upon receiving the input, may show the viewer (i.e., the technician) an animation of the wire loom 102 on the display 402, represented by the wire loom image 102′ from the starting point to the end point, as illustrated with respect to FIGS. 9A-9C. As discussed, the animation may be pausable and replayable using, for example, the pause icon 704d and the play icon 704c, respectively. Further, the technician viewing the animation may be able to skip to a beginning and an end of the animation using the rewind icon 704a and the forward icon 704e, respectively. The animation may proceed from displaying the first vehicle component image 110(1)′ to the third vehicle component image 702 to the second vehicle component image 110(2)′. In one aspect, the animation may show only one of the plurality of wire connections 202, based upon the input from the technician received on the processor 502. For example, upon displaying the wire traces 708, the processor 502 may receive an input requesting that only one of the wire traces 708 may be displayed in the animation. Accordingly, the processor 502 may generate the animation to display only the requested wire trace in the plurality of wire connections 202 corresponding to one of the wires 202(1)-202(m). In yet another aspect, the processor 502 may display both the wire loom image 102′ and internally the plurality of wires 202(1)-202(m).

In an operation 1016, the processor 502 may identify at least one fault location in one or more of the plurality of wire connections 202 in the wire loom 102 based upon the animation as part of the display of the wire loom image 102′. For example, the fault location may be displayed as shown in FIG. 8 at the third vehicle component image 702 (e.g., a splice in the wire loom 102). In one aspect, alternatively or additionally, such identification fault location may include an audio output or a visual output indicating the fault location in one or more of the plurality of wire connections 202. For example, the display 402 may show a graphic pointing to the fault location and output a beep to bring the technician attention to where in the wire loom 102 a fault may be possible. Accordingly, the technician may be able to diagnose the wire loom 102 at that particular fault location, rather than looking for each and every intermediate vehicle component between the first vehicle component 110(1) and the second vehicle component 110(2).

In an operation 1018, the processor 502 may provide an indication of the cutting depth 802 of the wire connection at the fault location identified for the wire connection from the operation 1016. Such an indication of the cutting depth 802 may be in the form of a numerical value displayed on the display 402 (e.g., 2 mm). Alternatively or additionally, the cutting depth 802 may be indicated to begin from a first wire (e.g., 202(1)) and end at a second wire (e.g., 202(2)) in the wire loom 102 represented by the wire loom image 102′. For example, the first wire may be black in color and the second wire may be green in color, and the indication of the cutting depth 802 may illustrate to the technician that a cutting of the wire loom 102 has to be form the first black colored wire to the first green colored wire within the wire loom 102. Further, the animation may include the wire loom image 102′ being cut and opened to the cutting depth 802 as a visual cue to the technician attempting to cut the wire loom 102. The cutting depth 802, as provided on the display, avoids the wire loom 102 and/or one or more of the plurality of wire connections 202 from being overcut or being damaged.

In an operation 1020, the processor 502 may provide audio output or visual output or both associated with the animation. For example, the processor 502 may provide audio cues to the technician indicating where the fault location might be present on the wire loom 102, as part of the animation, or independently. Such audio or visual outputs may be based on at least one of a location and color of the first vehicle component 110(1). For example, the first vehicle component 110(1) may be a green colored connector located near an alternator (not shown) of the vehicle 100, and the processor 502 may indicate to the technician that based upon the green color and the location of the first vehicle component 110(1), the first vehicle component 110(1) is an output port of the alternator. Furthermore, the wireless device 400 may project the animation onto an external surface (e.g., a surface of the vehicle 100) to see the animation in a bigger format. For example, a “project display” or a “share display” feature of the display 402 may be implemented by the processor 502 to view the wire loom image 102′ in the interactive wiring diagram 700 (in FIG. 7), the cutting depth 802 (in FIG. 8), and/or the animation in FIGS. 9A-9C onto a side body of the vehicle 100 (not shown) or to another wired or wireless device with a bigger display (if available).

In one aspect, in the method 1000, one or more processes or operations, or sub-processes thereof, may be skipped or combined as a single process or operation, and a flow of processes or operations in the method 1000 may be in any order not limited by the specific order illustrated in FIG. 10. For example, one or more processes or operations may be moved around in terms of their respective orders, or may be carried out in parallel. The term “flow,” as used with respect to FIG. 10, generally refers to a logical progression of operations in an exemplary manner carried out for providing the interactive wiring diagram 700. However, such a flow is by way of example only and not by way of limitation, as at a time, the flow may proceed along multiple operations or processes of the method 1000.

Various aspects of this disclosure provide numerous exemplary advantages.

An exemplary advantage is the ability to trace a circuit from the wireless device 400 (e.g., a mobile device) where the screen space of the display 402 is limited by the dimensions D₁ and D₂.

Another exemplary advantage is the interactive capability of the interactive wiring diagram 700 allows for a “journey” through the circuit to be analyzed in the vehicle 100 in which splices, connectors, bulk heads, grounds, etc. are accounted for.

Another exemplary advantage is that since the interactive wiring diagram 700 is in an electronic format, is dynamic and can show a location of one or more components in the vehicle components 110(1)-110(n), including those that are not directly visible to the technician.

Another exemplary advantage is that in many situations, a technician may cut into a wiring loom looking for a high failure rate splice, often cutting far more of the loom than necessary. Using the location capabilities according to the aspect of this disclosure, the cutting depth 802 is indicated on the display 402 accurately at points where cutting is recommended to fault analysis or repair, showing the correct depth to cut to as an animation to the technician, and therefore minimizing chances for over-cutting the wires 202(1)-202(m) or the wire loom 102.

Another advantage is that the technician would only need to know the starting point and the end point of the circuit to diagnose making it easier to diagnose the circuit. Traditional wiring diagrams require the technician to know pin numbers of the electrical connectors 304, which is often cumbersome and prone to human error.

The many features and advantages of the present disclosure are apparent from the detailed specification, and thus, it is intended by the appended claims to cover all such features and advantages of the present disclosure, which fall within the true spirit, and scope of the present disclosure. Further, since numerous modifications and variations will readily occur to those skilled in the art, it is not desired to limit the present disclosure to the exact construction and operation illustrated and described, and accordingly, all suitable modifications and equivalents may be resorted to, falling within the scope of the present disclosure.

What is claimed is:

1. A method for providing an interactive wiring diagram, comprising:
receiving, at a processor of a wireless device, from an image sensor of the wireless device, an image of a wire loom between a first vehicle component and a second vehicle component of a vehicle, the wire loom including a plurality of wire connections of the vehicle;
determining, using a position sensor of the wireless device, a position of the wire loom relative to the vehicle and to the wireless device;
identifying, using a database connected to the processor, a wire connection based upon at least the image or the position of the wire loom;
generating, using the processor, an interactive wiring diagram of the wire connection based upon the identifying, the interactive wiring diagram including a trace route indicating a presence of at least a third vehicle component between the first vehicle component and the second vehicle component;
displaying, using the processor, the interactive wiring diagram on a display of the wireless device;
receiving, at the processor, an input specifying a starting point and an end point in the trace route; and
providing, using the processor, an animation of the interactive wiring diagram based upon the starting point and the end point on the display based upon the input received at the processor.

2. The method of claim 1, wherein the starting point is the first vehicle component of the wire connection and the end point is the second vehicle component of the wire connection in the wire loom.

3. The method of claim 1, wherein the animation includes a view of the trace route scalable according to one or more dimensions of the display.

4. The method of claim 1, wherein the wireless device is a mobile phone or a mobile computing device, the first vehicle component is a sensor of the vehicle, the second vehicle component is an electronic control module of the vehicle, and the third vehicle component is one of a splice, a connector, a bulk head, or an electrical ground point of the vehicle.

5. The method of claim 1, further comprising:
providing, using the processor, an audio output or a visual output of at least one of a location and a color of at least one of the first vehicle component, the second vehicle component, and the third vehicle component in the animation.

6. The method of claim 1, wherein the animation is pausable and replayable based upon a pause input and a play input, respectively, received at the processor.

7. The method of claim 1, further comprising:
identifying, using the processor, at least one fault location in the wire connection based upon the animation, said identifying including an audio output or a visual output indicating the fault location in the wire connection.

8. The method of claim 7, wherein the animation includes an indication of a cutting depth of the wire connection at the fault location identified for the wire connection.

9. The method of claim 7, further comprising:
providing, using the processor, an indication of a cutting depth of the wire connection at the fault location identified for the wire connection as an output of the wireless device.

10. A system for providing an interactive wiring diagram, comprising:
a wire loom between a first vehicle component and a second vehicle component of a vehicle, said wire loom including a plurality of wire connections; and
a wireless device including at least:
an image sensor,
a position sensor,
a display,
a memory including processor executable instructions, and
a processor coupled to the memory, the display, the image sensor, and the position sensor,
wherein the processor, upon an execution of the processor executable instructions, is configured to:
receive, from the image sensor of the wireless device, an image of the wire loom,
determine, using the position sensor of the wireless device, a position of the wire loom relative to the vehicle and to the wireless device,
identify, using a database connected to the processor, a wire connection in the wire loom based upon at least the image or the position of the wire loom,
generate an interactive wiring diagram of the wire connection after the wire connection has been identified, the interactive wiring diagram including a trace route indicating a presence of at least a third vehicle component between the first vehicle component and the second vehicle component,
display the interactive wiring diagram on the display of the wireless device,
receive an input specifying a starting point and an end point in the trace route, and
provide an animation of the interactive wiring diagram based upon the starting point and the end point on the display based upon the input received at the processor.

11. The system of claim 10, wherein the starting point is the first vehicle component of the wire connection and the end point is the second vehicle component of the wire connection in the wire loom.

12. The system of claim 10, wherein the animation includes a view of the trace route scalable according to one or more dimensions of the display.

13. The system of claim 10, wherein the wireless device is a mobile phone or a mobile computing device, the first vehicle component is a sensor of the vehicle, the second vehicle component is an electronic control module of the vehicle, and the third vehicle component is one of a splice, a connector, a bulk head, or an electrical ground point of the vehicle.

14. The system of claim 10, wherein the processor, upon the execution of the processor executable instructions, is further configured to:
provide an audio output or a visual output of at least one of a location and a color of at least one of the first vehicle component, the second vehicle component, and the third vehicle component in the animation.

15. The system of claim 10, wherein the animation is pausable and replayable based upon a pause input and a play input, respectively, received at the processor.

16. The system of claim 10, wherein the processor, upon the execution of the processor executable instructions, is further configured to:
identify at least one fault location in the wire connection based upon the animation, said identifying including an audio output or a visual output indicating the fault location in the wire connection.

17. The system of claim 16, wherein the animation includes an indication of a cutting depth of the wire connection at the fault location identified for the wire connection.

18. The system of claim 16, wherein the processor, upon the execution of the processor executable instructions, is further configured to:
provide an indication of a cutting depth of the wire connection at the fault location identified for the wire connection as an output of the wireless device.

19. A non-transitory computer readable medium of a wireless device including processor executable instructions stored thereupon for providing an interactive wiring diagram, the processor executable instructions when executed by a processor of the wireless device, cause the processor to:
receive, from an image sensor of the wireless device, an image of a wire loom between a first vehicle component and a second vehicle component of a vehicle, said wire loom including a plurality of wire connections,
determine, using a position sensor of the wireless device, a position of the wire loom relative to the vehicle and to the wireless device,
identify, using a database connected to the processor, a wire connection based upon at least the image or the position of the wire loom,
generate an interactive wiring diagram of the wire connection after the wire connection has been identified, the interactive wiring diagram including a trace route indicating a presence of at least a third vehicle component between the first vehicle component and the second vehicle component,
display the interactive wiring diagram on a display of the wireless device,
receive an input specifying a starting point and an end point in the trace route, and
provide an animation of the interactive wiring diagram based upon the starting point and the end point on the display based upon the input received at the processor.

20. The non-transitory computer readable medium of claim 19, wherein the animation includes a view of the trace route scalable according to one or more dimensions of the display.
